(19) United States
(12) Patent Application Publication
(10) Pub. No.: US 2018/0020492 A1
(43) Pub. Date: Jan. 18, 2018

(54) DYNAMIC PROVISIONING OF UNIQUE IDENTIFIER FOR ESTABLISHING PEER-TO-PEER CONNECTION

(71) Applicant: Xiaoyi Technology Co., Ltd., Shanghai (CN)

(72) Inventor: Eric DAO, Shanghai (CN)

(73) Assignee: Xiaoyi Technology Co., Ltd.

(21) Appl. No.: 15/222,087

(22) Filed: Jul. 28, 2016

(30) Foreign Application Priority Data
Jul. 18, 2016 (CN) 201610566327.4

(51) Int. Cl. H04W 76/02; H04L 12/24; H04L 29/08; H04W 4/00

(52) U.S. Cl. CPC H04W 76/021; H04W 4/008; H04L 41/0806; H04L 67/104

(57) ABSTRACT

Methods and apparatus for dynamically assigning a unique identifier (UID) are disclosed. According to certain embodiments, the methods may include transmitting a request for unique identifier (UID) to a server. The methods may also include receiving a UID assigned by the server. The methods may further include using a service that is rendered based on the UID.

### CROSS-REFERENCE TO RELATED APPLICATION

This application is based upon and claims priority from Chinese Patent Application No. 201610566327.4, filed on Jul. 18, 2016, the disclosure of which is expressly incorporated herein by reference in its entirety.

### TECHNICAL FIELD

The present disclosure relates generally to the field of communication technologies, and more particularly, to dynamic provisioning of a unique identifier for establishing a peer-to-peer connections.

### BACKGROUND

Internet of Things (IoT) is an interactive network of various appliances and electronic devices. Devices in the IoT are connected, accessed, monitored, and/or controlled through Web technologies. IoT service providers have been competing to offering a wide spectrum of IoT platforms (i.e., integrated IoT business solutions) for providing device connectivity, furnishing cloud service, managing and analyzing the big data generated by the devices, and developing the IoT applications.

Identities are the key to enabling any kind of interaction among devices. An IoT service provider may assign a unique identifier (UID) to a device that uses its platform, so that the IoT service provider can connect and manage the device according to the UID. Most IoT service providers charge a license fee for a UID. For example, if a smart camera (also known as IP camera or web camera) uses an IoT service provider's service for connecting to other devices, the smart camera may be given a UID. The camera manufacturer or the user may pay the IoT service provider a one-time or monthly fee for using the UID.

Conventionally, the UID may be assigned to the smart camera when the camera is still at the production line. For example, the UID may be printed on the camera case or the user's manual. As another example, the UID may be written into a non-volatile memory of the camera. However, this means that the camera manufacturer or user has to pay for the UID before it is actually used. Worse, if the UID is never used, the license fee paid for the UID goes wasted. Moreover, unless the camera is immediately bought by a user and connected to the IoT, the UID may continue to decay over time. That is, the UID may be hacked or become expired. Furthermore, the UID is assigned at a time when it is unknown where the camera will be used. If the camera is installed at a location where the IoT service provider associated with the UID has a poor coverage, the user is stuck with the experiences of delayed, slow, or unreliable connections.

The disclosed methods and systems address one or more of the problems listed above.

### SUMMARY

Consistent with one embodiment of the present disclosure, there is provided a method for a device to obtain a service. The method may include transmitting a request for unique identifier (UID) to a server. The method may also include receiving a UID assigned by the server. The method may further include using a service that is rendered based on the UID.

Consistent with another embodiment of the present disclosure, there is provided a device including a memory and a processor. The memory may store instructions. The processor may be configured to execute the instructions to: transmit a request for UID to a server; receive a UID assigned by the server; and use a service that is rendered based on the UID.

Consistent with another embodiment of the present disclosure, there is provided a method for a terminal to establish a connection with a device. The method may include transmitting a request for UID to a first server, the UID being used to identify the device. The method may also include receiving a UID assigned by the server. The method may also include transmitting the UID to the device. The method may further include forming a connection with the device based on the UID.

Consistent with another embodiment of the present disclosure, there is provided a terminal including a memory and a processor. The memory may store instructions. The processor may be configured to execute the instructions to: transmit a request for UID to a first server, the UID being used to identify a device; receive a UID assigned by the server; transmit the UID to the device; and form a connection between the terminal and the device based on the UID.

Consistent with yet another embodiment of the present disclosure, there is provided a method performed by a server. The method may include receiving, from a first device, a request to provide a UID to a second device. The method may also include determining whether the second device is authorized, based on an identity of the second device. The method may also include when it is determined that the second device is authorized, querying a database to obtain a UID based on a usage condition of the second device. The method may further include sending the UID to the first device.

It is to be understood that both the foregoing general description and the following detailed description are exemplary and explanatory only and are not restrictive of the invention, as claimed.

### DESCRIPTION OF DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram illustrating an Internet of Things, according to an exemplary embodiment.

FIG. 2 is a flowchart of a method for dynamically assigning a unique identifier, according to an exemplary embodiment.

FIG. 3 is a flowchart of a method for dynamically assigning a unique identifier, according to an exemplary embodiment

FIG. 4 is a schematic diagram illustrating an implementation of the method shown in FIG. 3, according to an exemplary embodiment.

FIG. 5 is a block diagram of a device for dynamically assigning a unique identifier, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

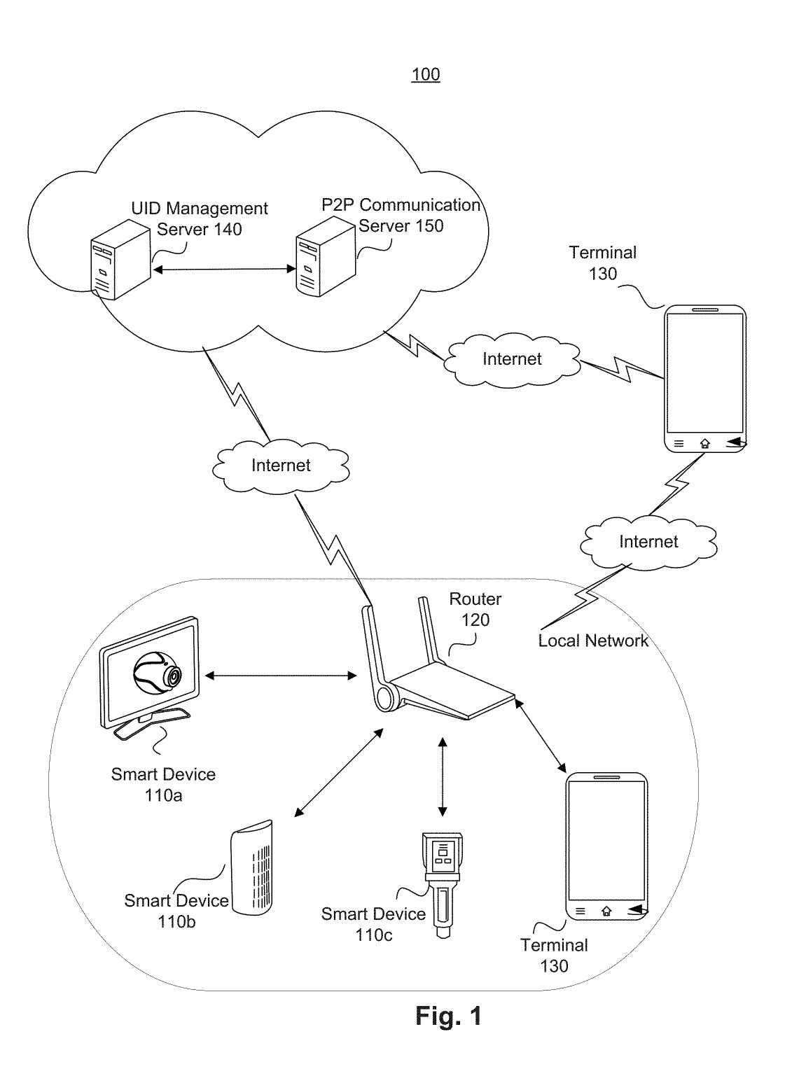

FIG. 1 is a schematic diagram illustrating an Internet of Things (IoT) 100, according to an exemplary embodiment. Referring to FIG. 1, IoT 100 may include a smart device 110 (e.g., a smart camera 110a, a smart air purifier 110b, and a smart water purifier 110c illustrated in FIG. 1), a router 120, a terminal 130, a UID management server 140, and a peer-to-peer (P2P) communication server 150.

Smart device 110 may be a device with certain computing and communication capabilities, such as a smart camera, a smart wearable device (e.g., a wrist band), a smart air conditioner, a smart air purifier, a smart water purifier, a smart refrigerator, a smart socket, a smart door bell, etc. For illustrative purpose only, the following description assumes smart device 110 to be a smart camera. Accordingly, “smart device 110” and “smart camera 110” will be used interchangeably this disclosure where it is applicable. Smart camera 110 may be configured to form wireless or wired communications with other devices, including router 120, terminal 130, UID management server 140, and P2P communication server 150. For example, smart camera 110 may include a built-in Wi-Fi module for wireless connection. Also for example, smart camera 110 may include a Universal Serial Bus (USB) interface by which router 120 may be connected.

Router 120 may be configured to establish a wireless or wired local network, such as a Wi-Fi network. Smart camera 110 may join the local network so as to connect to the Internet via the router 120 and communicate with terminal 130, UID management server 140, and P2P communication server 150.

Terminal 130 may be an electronic device containing a user interface. For example, terminal 130 may be a mobile phone, a tablet computer, a personal computer, a personal digital assistant (PDA), a remote controller, a medical device, exercise equipment, an ebook reader, a MP3 (Moving Picture Experts Group Audio Layer III) player, a MP4 player, etc. Terminal 130 may be configured to form wireless or wired communications with other devices, including smart camera 110, router 120, UID management server 140, and P2P communication server 150. When terminal 130 is at the same location as smart camera 110 and router 120, terminal 130 may join the local network established by router 120 and communicate with smart camera 110 via the local network. When terminal 130 is at a place distant from smart camera 110 and router 120, terminal 130 may connect to the Internet via another local network (not shown) or a cellular network (not shown), and then remotely access smart camera 110.

Terminal 130 may receive input from a user and output information to the user through the user interface. In some embodiments, the user interface may include input devices, such as a touchscreen, a keyboard, a mouse, and/or a tracker ball, so that the user may enter various commands and data for controlling and managing smart camera 110. For example, the user may use the user interface to initiate an application for connecting terminal 130 to smart camera 110. For another example, if smart camera 110 is a pan-tilt-zoom (PTZ) camera, the user may control the PTZ movement of smart camera 110 through the user interface. In some embodiments, the user interface may also include a screen for displaying the image information captured by smart camera 110. For example, the screen may be a Liquid Crystal Display (LCD), a Light Emitting Diode (LED) display, a plasma display, or any other type of display.

Each of UID management server 140 and P2P communication server 150 may be a general purpose computer, a mainframe computer, or any combination of these components, and may be implemented as a server, a server cluster consisting of a plurality of servers, or a cloud computing service center. Each of UID management server 140 and P2P communication server 150 may be operated by an IoT service provider, or a manufacturer or seller of smart camera 110. As described in more detail below, UID management server 140 is configured to dynamically assign a UID to a smart device 110 based on a usage condition of smart camera 110, and P2P communication server 150 is configured to facilitate the formation of a P2P connection between smart camera 110 and terminal 130. In some embodiments, the functions of UID management server 140 and P2P communication server 150 may be integrated into one server. In some embodiments, multiple UID management servers 140 and/or P2P communication servers 150 may collaborate to perform functions consistent with the present disclosure.

In practice, after purchasing a smart camera 110, a user may install smart camera 110 at a desired place, such as the user's home, in which router 120 is used to establish a local network. Smart camera 110 may connect to the Internet via router 120. The user may pair terminal 130 with smart camera 110, so that terminal 130 may communicate with smart camera 110 and display live images captured by smart camera 110. For example, when the user is travelling away from home, the user may view the conditions at home on terminal 130.

To enable terminal 130 to remotely access smart camera 110, the user may be required to manually set the network parameters for smart camera 110. Such setup is rather complicated. For example, in the event that smart camera 110 is designed to wirelessly connect to the Internet, the user needs to operate terminal 130 to search for a wireless Access Point (AP) base station, set a password for accessing the AP base station, set a base station network packet forwarding address, etc. Smart camera 110 can be connected to the network only after said wireless network initialization settings are completed, which causes great inconvenience to the user.

Consistent with the disclosed embodiments, P2P technology may be used to simplify the process of connecting smart camera 110 to terminal 130. Specifically, an IoT service provider may assign a UID to smart camera 110. The UID is used to identify smart camera 110 in a network of devices. The user may initiate an application in terminal 130 to ping P2P communication server 150 operated by the IoT service provider. P2P communication server 150 in turn pings smart camera 110 according to the UID. If smart camera 110 can be pinged, P2P communication server 150 may create a direct connection between smart camera 110 and terminal 130, and manage direct transmission of image data from smart camera 110 to terminal 130. For example, P2P communication server 150 may assist in processing the data packets transmitted from smart camera 110, such that the data packets can bypass a firewall of router 120. This way, smart camera 110 can be automatically connected to terminal 130, with minimum input from the user. Therefore, the plug and play (PnP) of smart camera 110 is realized and the user experience of smart camera 110 is greatly improved.

In practice, the IoT service provider may be an entity independent from the manufacturer and seller of smart camera 110. Thus, the manufacturer needs to form service agreements with one or more IoT service providers, so that smart device 110 may use the P2P connection service provided by the IoT service providers. For example, when smart device 110 is manufactured, the manufacturer may purchase a UID from an IoT service provider and print the UID on the case or user's manual of smart camera 110. However, this way of provisioning UID not only makes the manufacturer and eventually the user to pay for the UID long before the actual usage of smart camera 110, but also risks the expiring and stealing of the UID before the actual usage. More importantly, if the IoT service provider associated with the originally assigned UID has a poor coverage in the area where smart camera 110 is used, the user has to either suffer bad P2P connections or go through tremendous trouble of switching to another UID and IoT service provider. To overcome at least these problems, the present disclosure provides methods and devices for dynamically assigning a UID based on the actual usage condition of smart camera 110.

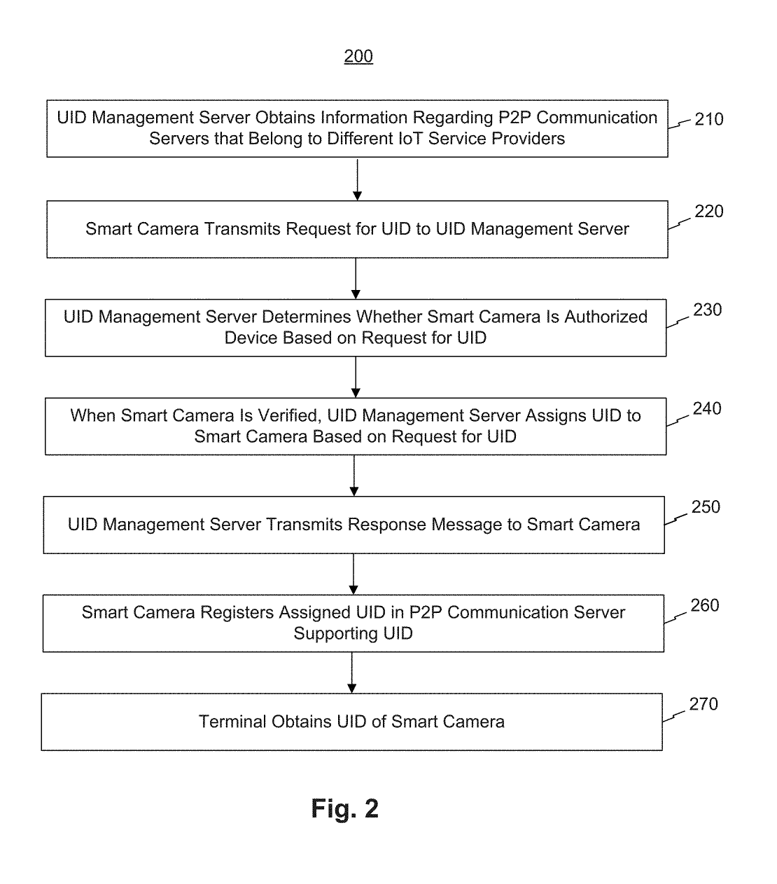

FIG. 2 is a flowchart of a method 200 for dynamically assigning a UID, according to an exemplary embodiment. For example, method 200 may be performed in IoT 100, when smart camera 110 is connected to terminal 130 for the first time. Referring to FIG. 2, method 200 may include the following steps.

In step 210, UID management server 140 obtains information regarding P2P communication servers 150 that belong to different IoT service providers. In one embodiment, UID management server 140 is operated by the manufacturer of smart camera 110. The manufacturer may have P2P service agreements with multiple IoT service providers. Based on the service agreements, UID management server 140 may store and periodically update a server list containing a plurality of P2P communication servers 150 that are managed by different IoT service providers, placed at different geographic locations, and/or configured to support different types of smart devices. The server list may include various information regarding P2P communication servers 150, such as the IP addresses, specifications, actual configurations, and/or operating status.

In step 220, smart camera 110 transmits a request for UID to UID management server 140. In exemplary embodiments, smart camera 110 originally has no UID. The transmission of the request for UID may be initiated in various manners. For example, when smart camera 110 connects to the Internet for the first time, smart camera 110 may transmit the request for UID to UID management server 140. For another example, there may be provided a user-operated button on smart camera 110 so that the user may initiate the request. When the user wants to obtain a UID for smart camera 110, the user may push the button so that smart camera 110 will automatically send the request for UID. For yet another example, after the user initiates an application in terminal 130 for setting up a connection between smart camera 110 and terminal 130 for the first time, terminal 130 may broadcast a message, which instructs smart camera 110 to send the request for UID to UID management server 140.

The request for UID may include the information required by UID management server 140 for assigning the UID. For example, the request may include identity information of smart camera 110, such as the serial number and/or machine access control (MAC) address of smart camera 110. For another example, the request may include information regarding the usage condition of smart camera 110, such as the IP address and/or Global Positioning System (GPS) coordinates of smart camera 110.

In step 230, UID management server 140 determines whether smart camera 110 is an authorized device based on the request for UID. UID management server 140 may store a device list that includes data of smart devices manufactured by the manufacturer of smart camera 110. UID management server 140 may query the device list to verify whether smart camera 110 is indeed produced by the manufacturer of smart camera 110. For example, if the device list contains the serial number of smart camera 110, UID management server 150 may verify that smart camera 110 is an authorized device.

In step 240, when smart camera 110 is verified, UID management server 140 assigns a UID to smart camera 110 based on the request for UID. In one embodiment, UID management server 140 may assign the UID based on the geographic location of smart camera 110. Specifically, UID management server 140 may determine the geographic location of smart camera 110 based on the IP address and/or GPS coordinates of smart camera 110. UID management server 140 may then select an IoT service provider that has a good coverage in this geographic location. UID management server 140 may then retrieve a UID supported by the selected IoT service provider and assign the UID to smart camera 110. UID management server 140 may also update the device list to include the newly assigned UID for smart device 110.

In one implementation consistent with the disclosed embodiments, UID management server 140 may store a service map for the IoT service providers that have service agreements with the manufacturer of smart camera 110. The service map may delineate the areas in which the IoT service providers offer service and list information regarding the service ratings of each IoT service provider in the respective areas. The service map may further indicate the numbers and locations of P2P communication servers 150 operated by each IoT service provider. Based on the service map, UID management server 140 may select an IoT service provider that may work best for smart camera 110.

For example, if the service map shows that IoT service provider A has more P2P communication servers 150 and higher service ratings in the geographic location of smart device 110 than IoT service provider B, UID management server 140 may select IoT service provider A to provide the P2P connection service for smart camera 110. UID management server 140 may then access a pool of unused UIDs stored in UID management server 140, or a P2P communication server 150 or a database operated by the selected IoT service provider, to retrieve an unused UID supported by the selected IoT service provider. This UID will be assigned to smart camera 110.

In some embodiments, UID management server 140 may assign the UID based on other properties of smart camera 110. For example, UID management server 140 may assign the UID based on the model of smart camera 110. Moreover, as described above, the present disclosure is intended to be applied to any smart device 110. The manufacturer of smart device 110 may use different IoT service providers to support different types of smart devices 110. Accordingly, UID management server 140 may assign the UID based on the type of smart device 110.

In step 250, UID management server 140 transmits a response message to smart camera 110. If smart camera 110 is not verified in step 230, the response message may indicate that request for UID is rejected and/or include an error code indicating the reason of the rejection. If smart camera 110 is verified in step 230, the response message may include the assigned UID and/or other information related to the selected IoT service provider. For example, UID management server 140 may select a P2P communication server 150 that supports the assigned UID and is near the location of smart camera 110, and return the connection information (e.g., IP address) of the selected P2P communication server 150 to smart camera 110.

In one embodiment, UID management server 140 may encrypt the response message using any method known in the art, to prevent the UID from being intercepted by unauthorized users. Correspondingly, smart camera 110 may decrypt the response message using methods consistent with the methods employed by UID management server 140 to generate the response message.

In step 260, smart camera 110 registers the assigned UID in a P2P communication server 150 supporting the UID. Smart camera 110 may connect to the P2P communication server 150 based on the received response message. For example, if the response message include the IP address of a designated P2P communication server 150, smart camera 110 may connect to the designated P2P communication server 150 and register the assigned UID in the designated P2P communication server 150. For another example, smart camera 110 may pre-store the IP address of a default P2P communication server 150 for each IoT service provider. Smart camera 110 may determine the IoT service provider supporting the assigned UID, based on the response message. Smart camera 110 may then connects to and register the assigned UID in the default P2P communication server 150 operated by the IoT service provider.

In exemplary embodiments, besides the assigned UID, smart camera 110 may also register other identity information of smart camera 110 in P2P communication server 150. Such identity information may be required by P2P communication server 150 to form the P2P connection and may include the IP address, MAC address, and/or serial number of smart camera 110.

In step 270, terminal 130 obtains the UID of smart camera 110. Terminal 130 may obtain the UID in various manners. In one embodiment, terminal 130 may inquire UID management server 140 about the UID newly assigned to smart camera 110. For example, terminal 130 may send the serial number and/or MAC address of smart camera 110 to UID management server 140. If determining a UID matches the received serial number and/or MAC address, UID management server 140 may return the matched UID to terminal 130. For security reasons, UID management server 140 may require terminal 130 to enter a user name and/or password, so as to ensure terminal 130 is a trusted device. UID management server 140 may also send the UID to terminal 130 in an encrypted message.

In another embodiment, terminal 130 may obtain the UID from smart camera 110 via a wired connection. For example, since smart camera 110 and terminal 130 are usually at the same location when the P2P connection is set up for the first time, a communication cable may be used to connect smart camera 110 and terminal 130, to enable data transmission between these two devices.

In another embodiment, terminal 130 may obtain the UID from smart camera 110 via near-field communication (NEC). For example, each of smart camera 110 and terminal 130 may have a NFC module for exchanging information in a short range. Specifically, the user may place terminal 130 in the vicinity of or in contact with smart camera 110, so that terminal 130 may read the newly assigned UID from smart camera 110.

In yet another example, smart camera 110 may broadcast the UID in encrypted messages to terminal 130 via various wireless signals, such as Wi-Fi, Bluetooth, or infrared signals. For example, smart camera 110 may broadcast the encrypted UID using the Bluetooth Low Energy (BLE) technology. Specifically, smart camera 110 may periodically transmit a BLE advertising packet containing the UID, and terminal 130 may scan for the advertising packet. After obtaining the advertising packet, terminal 130 may decrypt the packet and extract the UID.

In exemplary embodiments, terminal 130 may also obtain information regarding P2P communication server 150 and/or the IoT service provider that support the UID. For example, the information regarding P2P communication server 150 and/or the IoT service provider may be transmitted to terminal 130 together with the UID. Alternatively, after obtaining the UID, terminal 130 may search for the information regarding P2P communication server 150 and/or the IoT service provider based on the UID. Terminal 130 may search for such information on the Internet, in the database stored in UID management server 140 or terminal 130 itself.

After obtaining the UID and the information regarding P2P communication server 150 and/or the IoT service provider that supports the UID, terminal 130 may sent to P2P communication server 150 a request for establishing a P2P connection between smart camera 110 and terminal 130. The request includes the UID of smart camera 110.

P2P communication server 150 may facilitate the forming of a P2P connection using any method known in the art. For example, P2P communication server 150 may first attempt to use “hole-punching” technology to establish the P2P connection. In the hole-punching process, P2P communication server 150 may reply to terminal 130 with a message containing the public and private endpoints (i.e., the pair of IP address and port number) of smart camera 110. Meanwhile, P2P communication server 150 may send to smart camera 110 a connection request message containing the public and private endpoints of terminal 130. Afterwards, smart camera 110 and terminal 130 may send data packets to each other at the respective endpoints.

If the hole-punching process is successful, the P2P connection is formed, and terminal 130 may obtain the image data of smart camera 110 and/or control smart camera 110 via the P2P connection. If the hole-punching process fails, P2P communication server 150 may instead work as a transit point to relay information between smart camera 110 and terminal 130.

Using method 200 set forth above, smart camera 110 need not be assigned a UID when smart camera 110 is manufactured. Instead, the UID may be assigned when smart camera 110 is connected to terminal 130 for the first time. Therefore, method 200 reduces unnecessary cost for the manufacturer and user of smart camera 110. For the same reason, method 200 ensures that the UID is valid when it is used, and reduces the chances for the UID being hacked. Moreover, because the UID is automatically assigned, method 200 reduces the errors of manually inputting the UID. Furthermore, the UID is assigned based on the actual usage condition of smart camera 110, such as the geographic location of smart camera 110. Therefore, method 200 may select the UID and IoT service provider that work best for smart camera 110.

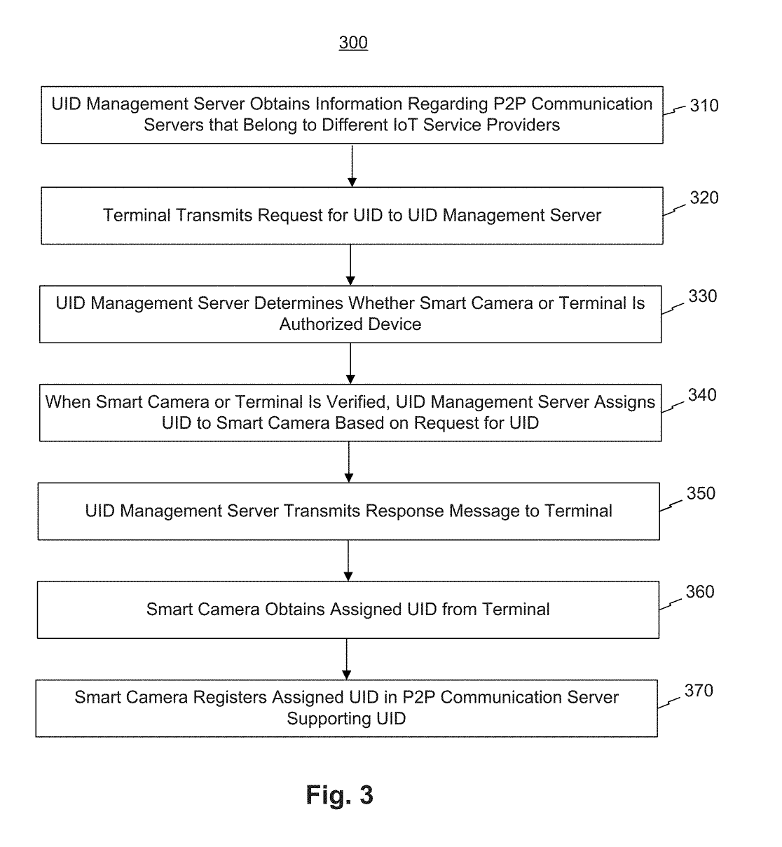

In method 200, the request for UID is initiated by smart camera 110. In embodiments consistent with the present disclosure, the request for UID may also be initiated by terminal 130. FIG. 3 is a flowchart of a method 300 for dynamically assigning a UID, according to an exemplary embodiment. For example, method 300 may be performed in IoT 100, when smart camera 110 is connected to terminal 130 for the first time. Referring to FIG. 3, method 300 may include the following steps.

In step 310, UID management server 140 obtains information regarding P2P communication servers 150 that belong to different IoT service providers. Step 310 is similar to step 210 (FIG. 2).

In step 320, terminal 130 transmits a request for UID to UID management server 140. In one embodiment, when a user initiates an application in terminal 130 for establishing a connection with smart camera 110, terminal 130 may transmit the request for UID to UID management server 140. Similar to step 220 (FIG. 2), the request for UID may include the serial number, MAC address, IP address, and/or geographic location of smart camera 110. Terminal 130 may use a built-in image sensor to scan the serial number and/or MAC address printed on the case or manual of smart camera 110. The user may also manually input the serial number and/or MAC address into terminal 130. Moreover, when the user sets up the connection between smart camera 110 and terminal 130 for the first time, both of the devices are in the same local network established by router 120. Terminal 130 may discover smart camera 110 in the local network and obtain the IP address of smart camera 110. Terminal 130 may also use a built-in GPS module to determine the geographic location of terminal 130, and treat this GPS location as the geographic location of smart camera 110.

In step 330, UID management server 140 determines whether smart camera 110 or terminal 130 is an authorized device. Similar to step 230 (FIG. 2), UID management server 140 may determine whether smart camera 110 is an authorized device based on the request for UID. Alternatively, UID management server 140 may require terminal 130 to enter a user name and password, so as to determine whether terminal 130 is an authorized device.

In step 340, when smart camera 110 or terminal 130 is verified, UID management server 140 assigns a UID to smart camera 110 based on the request for UID. The process of assigning the UID is similar to step 240 (FIG. 2).

In step 350, UID management server 140 transmits a response message to terminal 130. If neither smart camera 110 nor terminal 130 can be verified in step 330, the response message may indicate that request for UID is rejected and/or include an error code indicating the reason of the rejection. If smart camera 110 and/or terminal 130 can be verified in step 330, the response message may include the assigned UID and/or other information related to the selected IoT service provider.

In step 360, smart camera 110 obtains the assigned UID from terminal 130. Smart camera 110 may obtain the UID in a way similar to the ones described in step 270 (FIG. 2), i.e., inquiring UID management server 140 or using technologies such as Wi-Fi, Bluetooth, infrared, etc.

Moreover, smart camera 110 may obtain the UID using an optical method, such as through a graphic code. For example, the graphic code may be a one-dimensional bar code, a two-dimensional bar code, a two-dimensional quick response (QR) code, a three-dimensional code, an augmented reality code, etc. Taking QR code as an example, terminal 130 may generate a QR code according to the newly assigned UID. In one embodiment, terminal 130 may use an encryption method to generate the QR code to prevent an unauthorized device from deciphering the QR code. Terminal 130 may display the QR code on the user interface of terminal 130. Smart camera 110 may then scan the QR code displayed by terminal 130.

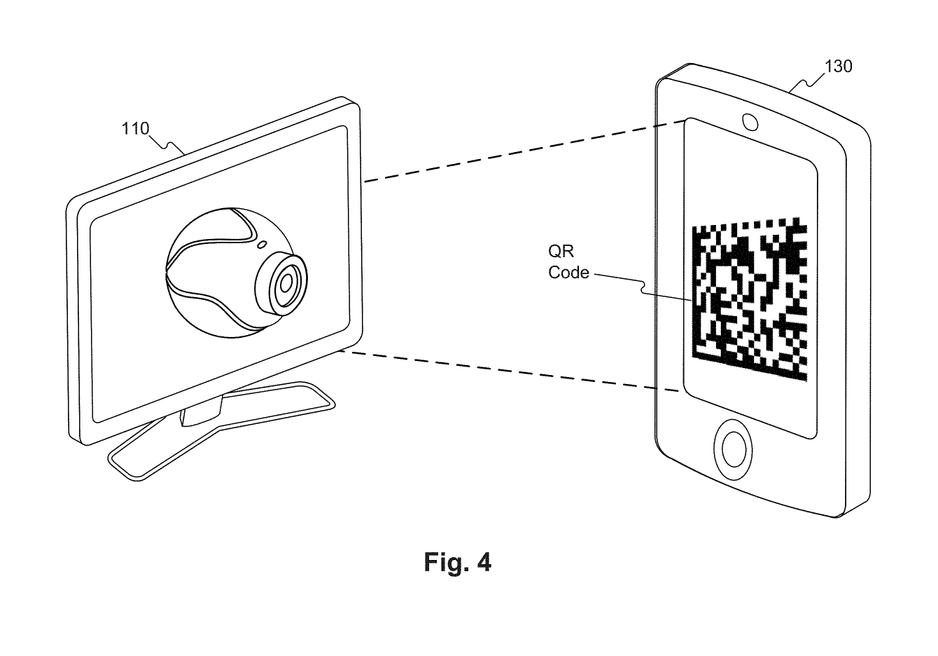

FIG. 4 is a schematic diagram illustrating an implementation of method 300, according to an exemplary embodiment. Referring to FIG. 4, the user may hold terminal 130 in front of smart device 110 and facing the QR code to the imaging direction of smart device 110. Smart device 110 may shoot an image of the QR code and decipher the QR code to extract the newly assigned UID.

In step 370 (FIG. 3), smart camera 110 registers the assigned UID in a P2P communication server 150 supporting the UID. Step 370 is similar to step 260 (FIG. 2).

The above-described methods provide exemplary ways for dynamically assigning a UID to smart camera 110. It is contemplated that these methods can be used to assign a UID in a variety of situations. For example, if the user finds the current UID is compromised, has expired, or no longer provides good P2P connections, methods 200 or 300 may be performed to assign a new UID to smart camera 110.

Moreover, it is contemplated that the above-described methods may be modified without deviating from the scope and spirit of the present disclosure. For example, the steps performed by UID management server 140 and P2P communication server 150 may be performed by a signal server. For another example, instead of having smart camera 110 register the assigned UID in P2P communication server 150, steps 260 and 370 may have terminal 130 or UID management server 140 register the assigned UID in P2P communication server 150.

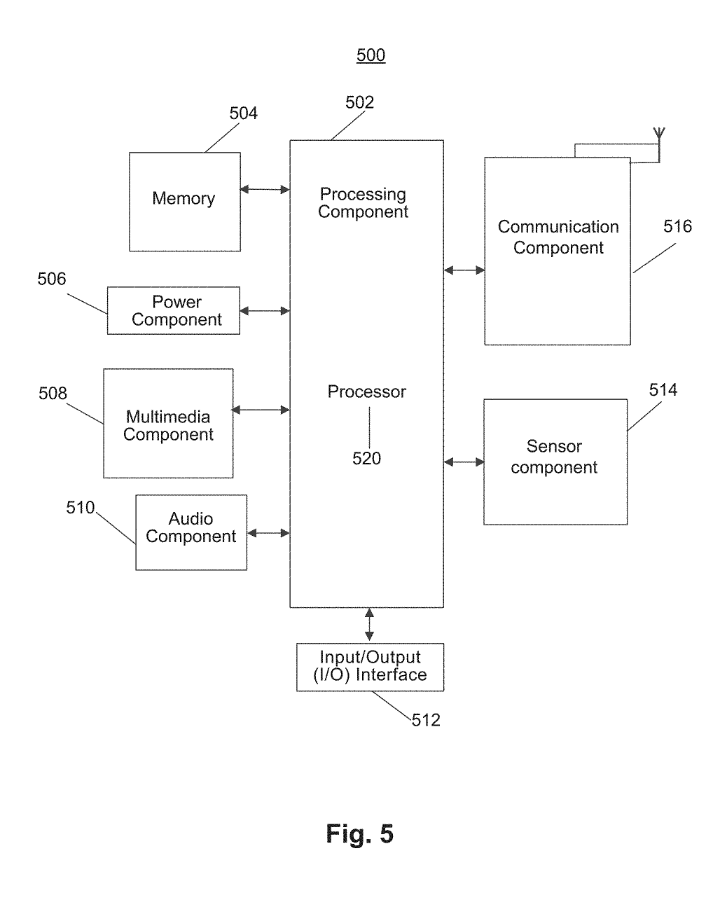

FIG. 5 is a block diagram of a device 500 for dynamically assigning a UID, according to an exemplary embodiment. For example, device 500 may be implemented as smart device 110 or terminal 130. Referring to FIG. 5, device 500 may include one or more of the following components: a processing component 502, a memory 504, a power component 506, a multimedia component 508, an audio component 510, an input/output (I/O) interface 512, a sensor component 514, and a communication component 516.

Processing component 502 may be configured to control overall operations of device 500, such as the operations associated with display, telephone calls, data communications, camera operations, and recording operations. Processing component 502 may include one or more processors 520 to execute instructions to perform all or part of the steps in the above described methods. Moreover, processing component 502 may include one or more modules which facilitate the interaction between processing component 502 and other components. For instance, processing component 502 may include a multimedia module to facilitate the interaction between multimedia component 508 and processing component 502.

Memory 504 may be configured to store various types of data to support the operation of device 500. Examples of such data include instructions for any applications or methods operated on device 500, contact data, phonebook data, messages, pictures, video, etc. Memory 504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, or a magnetic or optical disk.

Power component 506 may provide power to various components of device 500. Power component 506 may include a power management system, one or more power sources, and any other components associated with the generation, management, and distribution of operating power in device 500.

Multimedia component 508 may include a screen providing an output interface between device 500 and the user. In some embodiments, the screen may include a LCD and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, multimedia component 508 may include a front camera and/or a rear camera. The front camera and/or the rear camera may receive external multimedia data while device 500 is in an operation mode, such as a photographing mode or a video mode. Each of the front camera and the rear camera may be a fixed optical lens system or have focus and optical zoom capability.

Audio component 510 may be configured to output and/or input audio signals. For example, audio component 510 may include a microphone configured to receive an external audio signal when device 500 is in an operation mode, such as a call mode, a recording mode, and a voice recognition mode. The received audio signal may be further stored in memory 504 or transmitted via communication component 516. In some embodiments, audio component 510 may further include a speaker to output audio signals.

I/O interface 512 may provide an interface between processing component 502 and peripheral interface modules, such as a keyboard, a click wheel, buttons, and the like. The buttons may include, but are not limited to, a home button, a volume button, a starting button, and a locking button.

Sensor component 514 may include one or more sensors to provide status assessments of various aspects of device 500. For instance, sensor component 514 may detect an on/off status of device 500, relative positioning of components, e.g., the display and the keypad, of device 500, a change in position of device 500 or a component of device 500, a presence or absence of user contact with device 500, an orientation or an acceleration/deceleration of device 500, and a change in temperature of device 500. Sensor component 514 may include a proximity sensor configured to detect the presence of nearby objects without any physical contact. Sensor component 514 may also include a light sensor, such as a CMOS or CCD image sensor, for use in imaging applications. In some embodiments, sensor component 514 may also include a GPS receiver, an accelerometer, a gyroscope, a magnetic sensor, a pressure sensor, or a temperature sensor.

Communication component 516 may be configured to facilitate communication, wired or wirelessly, between the device 500 and other devices. Device 500 may access a wireless network based on one or more communication standard, such as Wi-Fi, LTE, 2G, 3G, 4G, 5G, etc. In one exemplary embodiment, communication component 516 may receive a broadcast signal or receive associated information from an external broadcast management system via a broadcast channel. In one exemplary embodiment, communication component 516 may further include a NFC module to facilitate short-range communications. In other embodiments, communication component 516 may be implemented based on a radio frequency identification (RFID) technology, an infrared data association (IrDA) technology, an ultra-wideband (UWB) technology, a Bluetooth technology, or other technologies.

In exemplary embodiments, device 500 may be implemented with one or more application-specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in memory 504, executable by processor 520 in the device 500, for performing the above-described methods. For example, the non-transitory computer-readable storage medium may be a read-only memory (ROM), a random access memory (RAM), a CD-ROM, a magnetic tape, a memory chip (or integrated circuit), a hard disc, a floppy disc, an optical data storage device, or the like.

Other embodiments of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact constructions that are described above and illustrated in the accompanying drawings, and that various modifications and changes can be made without departing from the scope thereof. It is intended that the scope of the invention should only be limited by the appended claims.

What is claimed is:

1. A method for a device to obtain a service, comprising:
transmitting a request for unique identifier (UID) to a server;
receiving a UID assigned by the server; and
using a service that is rendered based on the UID.

2. The method of claim 1, wherein using the service further comprises:
receiving information for forming a peer-to-peer (P2P) connection with a terminal.

3. The method of claim 1, wherein using the service further comprises:
before the service is used, registering the UID with a provider of the service.

4. The method of claim 1, wherein transmitting the request for UID further comprises:
determining that a condition has occurred; and
in response to the determination, transmitting the request for the UID to the server.

5. The method of claim 4, wherein the condition comprises at least one of:
the device is connected to a network;
the device receives an input from a user for forming a P2P connection with a terminal; or
the device receives a signal from the terminal for triggering the transmission of the request for UID.

6. The method of claim 1, wherein the request for UID:
includes information indicative an identity and a usage condition of the device, and
is configured to cause the server to assign the UID based on the usage condition.

7. The method of claim 6, wherein:
the usage condition includes a geographic location of the device; and
the request is further configured to cause the server to assign the UID based on the geographic location of the device.

8. The method of claim 6, wherein the request is further configured to cause the server to:
determine whether the device is authorized, based on the identity of the device; and
in response to the determination that the device is authorized, assign the UID.

9. The method of claim 1, wherein the request for UID includes at least one of a serial number, a machine access control (MAC) address, an Internet Protocol (IP) address, or Global Positioning System (GPS) coordinates of the device.

10. The method of claim 2, further comprising:
before the information is received, transmitting the UID to the terminal.

11. The method of claim 10, further comprising:
before transmitting the UID to the terminal, encrypting the UID.

12. The method of claim 10, wherein transmitting the UID to the terminal comprises:
transmitting the UID via at least one of a communication cable, near-field-communication (NFC), a Wi-Fi signal, a Bluetooth signal, or an infrared signal.

13. The method of claim 1, wherein receiving the UID comprises:
receiving the UID in an encrypted message; and
decrypting the message to retrieve the UID.

14. A device, comprising:
a memory storing instructions; and
a processor configured to execute the instructions to:
transmit a request for unique identifier (UID) to a server;
receive a UID assigned by the server; and
use a service that is rendered based on the UID.

15. A method for a terminal to establish a connection with a device, comprising:
transmitting a request for unique identifier (UID) to a first server, the UID being used to identify the device;
receiving a UID assigned by the server;
transmitting the UID to the device; and
forming a connection with the device based on the UID.

16. The method of claim 15, wherein the connection is a peer-to-peer (P2P) connection.

17. The method of claim 15, wherein:
the server is a first server; and
the method further comprises:
registering the UID in a second server.

18. The method of claim 15, wherein transmitting the request for UID comprises:
obtaining an identity and a usage condition of the device; and
incorporating the identity and the usage condition in the request for UID.

19. The method of claim 18, wherein the obtaining further comprises:
obtaining at least one of a serial number, a machine access control (MAC) address, an Internet Protocol (IP) address, or Global Positioning System (GPS) coordinates of the device.

20. The method according to claim 18, wherein the request for UID is configured to cause the server to assign the UID based on the usage condition.

21. The method of claim 20, wherein:
the usage condition includes a geographic location of the device; and
the request is further configured to cause the server to assign the UID based on the geographic location of the device.

22. The method of claim 18, wherein the request is further configured to cause the server to:
determine whether the device is authorized, based on the identity of the device; and
in response to the determination that the device is authorized, assign the UID.

23. The method of claim 15, further comprising:
before transmitting the UID to the device, encrypting the UID.

24. The method of claim 15, wherein transmitting the UID to the device comprises:
transmitting the UID via at least one of a communication cable, near-field-communication (NFC), a Wi-Fi signal, a Bluetooth signal, or an infrared signal.

25. The method of claim 15, wherein transmitting the UID to the device comprises:
generating a graphic code according to the UID; and
displaying the graphic code;
wherein the device scans the graphic code and determines the UID based on the graphic code.

26. The method of claim 15, wherein receiving the UID comprises:
receiving the UID in an encrypted message; and
decrypting the message to retrieve the UID.

27. A terminal, comprising:
a memory storing instructions; and
a processor configured to execute the instructions to:
transmit a request for unique identifier (UID) to a first server, the UID being used to identify a device;
receive a UID assigned by the server;
transmit the UID to the device; and
form a connection between the terminal and the device based on the UID.

28. A method performed by a server, comprising:
receiving, from a first device, a request to provide a unique identifier (UID) to a second device;
determining whether the second device is authorized, based on an identity of the second device;
when it is determined that the second device is authorized, querying a database to obtain a UID based on a usage condition of the second device; and
sending the UID to the first device.
